(19) United States
(12) Patent Application Publication
(10) Pub. No.: US 2009/0197571 A1
(43) Pub. Date: Aug. 6, 2009

(54) AUTHENTICATION INFORMATION REGISTRATION SYSTEM

(76) Inventors: Shigeki Kitajima, Kawasaki (JP); Kazuho Miki, Musashino (JP)

Correspondence Address: BRUNDIDGE & STANGER, P.C., 1700 DIAGONAL ROAD, SUITE 330, ALEXANDRIA, VA, 22314, US

(21) Appl. No.: 12/201,276

(22) Filed: Aug. 29, 2008

(30) Foreign Application Priority Data
Jan. 31, 2008 (JP) 2008-021789

(51) Int. Cl. H04M 1/66

(52) U.S. Cl. 455/411

(57) ABSTRACT

To provide technology whereby operations for registering authentication information when connecting wireless equipment to a network via an access point can be safely conducted at the store where the wireless equipment is purchased.

Member identification information identifying a user and identification information for a first access point disposed in relation to the user are stored in association with each other. The member identification information is received from a terminal installed at a store that receives wireless equipment. Subsequently, identification information for the wireless equipment is received from the wireless equipment via a second access point disposed in relation to the store. The first access point identification information associated with the received member identification information is then specified, and the received wireless equipment identification information is transmitted, via a network, to the first access point that was identified by the specified access point identification information.

### FIELD OF THE INVENTION

The present invention relates to technology for registering authentication information in an access point related to a user and wireless equipment.

### BACKGROUND OF THE INVENTION

In recent years, equipment used at home is increasingly used connected to a network. When connecting each piece of equipment to a network at home, some equipment may be difficult to connect using cables. For such equipment, it is suitable to connect to a network via an access point that communicates wirelessly with the equipment.

However, in this case, it is necessary for the user to perform cumbersome registration operations, such as manually inputting authentication information in the equipment and the access point, in order to prevent leakage of the information processed by the equipment to the houses adjacent to the user's house or other third parties. Furthermore, when there exists a plurality of equipments in the home that connects to a network via the access point (hereinafter referred to as wireless equipment), the user must perform registration operations with respect to each piece of wireless equipment, thus making the registration operations even more cumbersome.

In addition, users who are not skilled at performing operations for registering authentication information may have to request a person offering services for performing registration operations to come to the user's home and perform the registration operations. Thus, in present conditions, registration operations are very costly for such users.

Japanese Patent Application Publication No. 2006-135874 (hereinafter referred to as Patent Document 1) discloses technology whereby authentication information can be easily registered. Patent Document 1 discloses communications configuration means provided with functions enabling a wireless portable device to communicate and recharge power, functions for supplying power to a wireless portable device docked thereto, functions for authenticating the wireless portable device that are triggered when power supply to the wireless portable device commences, and functions for automatically forwarding to the wireless portable device various authentication information required for the wireless portable device to conduct communications control, such forwarding taking place when authentication is successful.

### SUMMARY OF THE INVENTION

However, in the technology disclosed in the Patent Document 1, since information exchange with the wireless portable device is conducted via a device junction, a support stand having charging functions that communicates with a wireless portable device is required for every single wireless portable device. In other words, when there exists a plurality of wireless equipments in the home, a number of support stands equal to the number of wireless portable devices becomes necessary. For this reason, when there exists a plurality of wireless portable devices in the home, there is a problem in that such a configuration is costly for the user.

The present invention has as an object to provide technology whereby the operations for registering authentication information when connecting wireless equipment to a network via an access point can be safely conducted at the store where the wireless equipment is purchased, and furthermore, wherein such technology can also be provided in the case where there exists a plurality of wireless equipments in the home.

The present invention is an authentication information registration system comprising a server, a device that acts as a first access point disposed in relation to a user, a terminal installed at a store that receives wireless equipment, and a device that acts as a second access point disposed in relation to the terminal, the above being connected via a network.

The terminal includes means for reading member identification information from a recording medium possessed by a user and storing member identification information identifying the user, and then transmitting such member identification information to the server via the network.

The server includes: means for storing the member identification information in association with access point identification information identifying the device that acts as the first access point;

means for receiving the member identification information from the terminal, and subsequently receiving wireless equipment identification information from the wireless equipment via the device that acts as the second access point;

means for specifying the access point identification information associated with the received member identification information;

and means for transmitting, via the network, the wireless equipment identification information received from the wireless equipment to the device that acts as the first access point that was identified using the specified access point identification information.

The device that acts as the first access point includes means for receiving the wireless equipment identification information from the server via the network, as well as for registering the wireless equipment identification information received from the server.

### BRIEF DESCRIPTION OF THE DRAWINGS

FIG. 1 shows the general configuration of the authentication information registration system of the present embodiment (at the time of purchase).

FIG. 2 shows the general configuration of the authentication information registration system of the present embodiment (after the user returns home).

FIG. 3 shows the hardware configuration of the store terminal 200 of the authentication information registration system of the present embodiment.

FIG. 4 shows the functional configuration of the member server 700 of the authentication information registration system of the present embodiment.

FIG. 5 shows the data structure of the member information 1000 of the authentication information registration system of the present embodiment.

FIG. 6 shows the data structure of the authentication information 2000 of the authentication information registration system of the present embodiment.

FIG. 7 shows the hardware configuration of the member server 700 of the authentication information registration system of the present embodiment.

FIG. 8 is a diagram explaining the processing conducted during advance registration of the wireless equipment at the store as part of the authentication information registration system of the present embodiment.

FIG. 9 is a diagram explaining the processing conducted during advance registration of the wireless equipment at the store as part of the authentication information registration system of the present embodiment.

FIG. 10 is a diagram explaining the processing conducted during advance registration of the wireless equipment at the store as part of the authentication information registration system of the present embodiment.

FIG. 11 is a diagram explaining the processing conducted during advance registration of the wireless equipment at the store as part of the authentication information registration system of the present embodiment.

FIG. 12 is a diagram explaining the processing conducted after advance registration at the store as part of the authentication information registration system of the present embodiment, in the case where the user AP 400 does not detect the wireless equipment 500 within the registration connection time limit.

FIG. 13 is a diagram explaining the processing conducted after advance registration at the store as part of the authentication information registration system of the present embodiment, in the case where the userAP 400 detects the wireless equipment 500 within the registration connection time limit.

FIG. 14 is a print example of the completed advance registration information 3000 printed by the printer 270 of the store terminal 200.

### EXPLANATION OF REFERENCE SIGNS

200: store terminal, 210: control device, 220: storage device, 230: communications equipment, 240: card reader, 250: display panel, 260: input device, 270: printer, 700: member server, 710: computing unit, 711: member information management unit, 712: authentication information management unit, 720: storage unit, 721: member information storage unit, 722: authentication information storage unit, 730: input/output unit, 740: network interface unit (IF unit), 910: computing device, 911: CPU, 912: primary storage device, 913: interface, 920: input device, 930: output device, 940: auxiliary storage device, 1000: member information, 2000: authentication information, 3000: completed advance registration information

### DETAILED DESCRIPTION OF THE EMBODIMENTS

Hereinafter, embodiments of the present invention will be described with reference to the accompanying drawings. In the following embodiments, a case is described, by way of example, wherein a user purchases wireless equipment 500 with the intention of connecting the wireless equipment 500 to a network via an access point at home, and furthermore wherein the authentication information therefor is registered at the store where the wireless equipment is purchased. The present embodiment is adaptable in the following cases when a user rents wireless equipment 500 at the store and the authentication information is registered at the store where the wireless equipment is rented, or when a user purchases or rents wireless equipment 500 with the intention of connecting the wireless equipment to a network via an access point other than at home (for example, access point at the office).

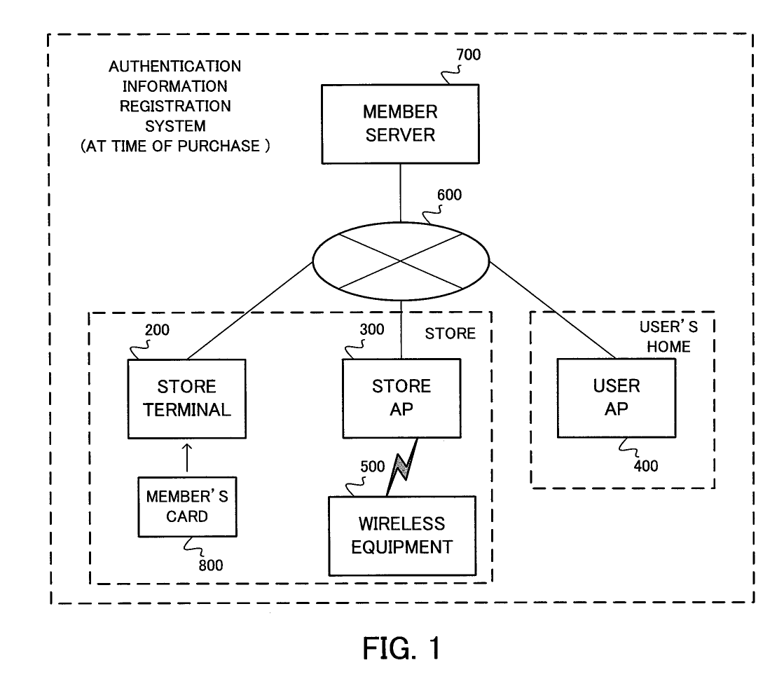

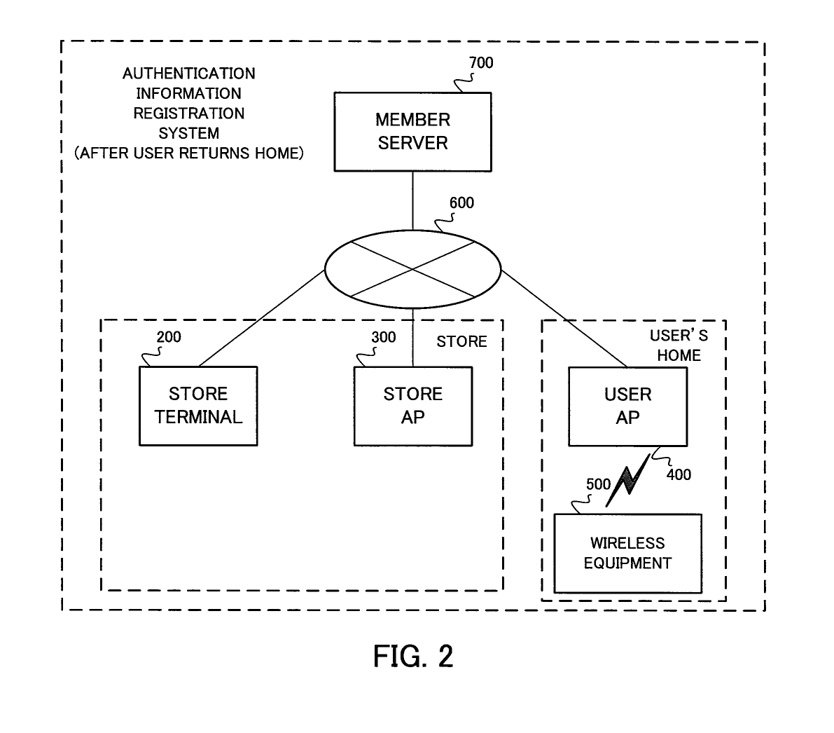

FIGS. 1 and 2 show the general configuration of the authentication information registration system of the present embodiment. FIG. 1 shows the general configuration of the authentication information registration system when the user purchases the wireless equipment 500. FIG. 2 shows the general configuration of the authentication information registration system after the user has purchased the wireless equipment 500 and returned home.

The authentication information registration system of the present embodiment includes: a member's card 800 issued at a store where the wireless equipment 500 can be purchased; a store terminal 200 installed at a store where the wireless equipment 500 can be purchased; a device 300 that acts as an access point, being disposed in relation to the store terminal 200 (hereinafter referred to as the store AP (Access Point) 300); a device 400 that acts as an access point, being disposed in relation to a user (hereinafter referred to as the userAP 400); and a member server 700.

The member server 700 is connected to the store terminal 200 via a network 600. In addition, the member server 700 is also connected to the store AP 300 as well as the user AP 400 via the network 600.

(Member's Card 800)

The member's card 800 is a card issued at a store where the wireless equipment 500 can be purchased. The member's card 800 stores a member ID (Identification; hereinafter abbreviated as ID) identifying a user. The member ID stored in the member's card 800 is read by means of a card reader 240 provided on the store terminal 200, to be hereinafter described. A magnetic card or an IC card, for example, may be used as the member's card 800. Of course, the member's card 800 is not limited to the above, and may be any storage medium that stores a member ID identifying a user.

(Store Terminal 200)

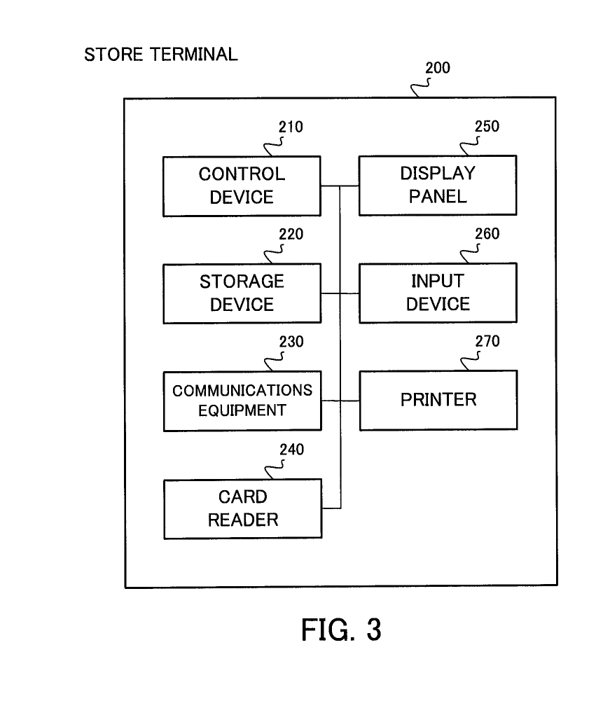

FIG. 3 shows the hardware configuration of the store terminal 200 in the authentication information registration system of the present embodiment.

The store terminal 200 includes a control device 210, a storage device 220, communications equipment 230, a card reader 240, a display panel 250, an input device 260, and a printer 270.

The communications equipment 230 controls the communication of information with the member server 700 via the network 600. The card reader 240 reads the member ID stored in the member's card 800 by means of a physical interaction with the member's card 800 (such as electromagnetic induction or electrostatic induction, for example) chosen according to the physical characteristics of the member's card 800. Upon the display panel 250 is displayed information received from the member server 700 via the communications equipment 230. The input device 260 receives input from a store employee who conducts registration operations by operating the store terminal 200 (hereinafter, this employee is referred to as the registration manager). The printer 270 prints information received from the member server 700 via the communications equipment 230.

The storage device 220 stores a store ID that identifies the store where the store terminal 200 is installed. In addition, the storage device 220 stores a registration manager ID that identifies the registration manager. The registration manager ID is received via the input device 260 of the store terminal 200 and stored in advance, before the registration operations commence.

The control device 210 exchanges information with the member server 700 via the communications equipment 230, while additionally controlling and processing information within the store terminal 200.

More specifically, the control device 210 transmits the member ID read by the card reader 240 to the member server 700 via the communications equipment 230. At this point, the member ID is transmitted along with the purchase date of the equipment (taken to be the data when the member ID is read), the store ID stored in the storage device 220, and the registration manager ID, the above being transmitted to the member server 700 via the communications equipment 230.

In addition, the control device 210 transmits input information received by the input device 260 to the member server 700 via the communications equipment 230.

Subsequently, the control device 210 receives the information transmitted from the member server 700 via the communications equipment 230, and displays the received information on the display panel 250. In addition, the control device 210 receives information transmitted from the member server 700 via the communications equipment 230, and causes the information to be printed by the printer 270.

(Store AP 300)

The hardware configuration of the store AP 300 is not shown in the drawings, but the store AP 300 is similar to a device including a CPU, a storage device, an input device, an output device, and an interface that acts as a typical access point.

The store AP 300 receives authentication information for the wireless equipment 500 in advance by means of the registration manager operating via the input device, and then stores this authentication information in the storage device.

(User AP 400)

The hardware configuration of the user AP 400 is not shown in the drawings, but the user AP 400 is similar to a device includes a CPU, a storage device, an input device, an output device, and an interface that acts as a typical access point.

Upon receiving information requesting the transmission of the WEP key currently in use from the member server 700 via the network 600, the userAP 400 transmits the WEP key currently in use to the member server 700 via the network 600.

In addition, the userAP 400 receives the MAC address and the registration connection time limit of the wireless equipment 500 from the member server 700 via the network 600. Subsequently, the received MAC address and the registration connection time limit of the wireless equipment 500 are registered in the storage device, and the user AP 400 tries to detect the wireless equipment 500. If the wireless equipment 500 is not detected within the registration connection time limit, then the userAP 400 transmits the MAC address of the wireless equipment 500 whose registration connection time limit has expired to the member server 700 via the network 600. In addition, the userAP 400 deletes the registered MAC address of the wireless equipment 500 whose registration connection time limit has expired. On the other hand, if the wireless equipment 500 is detected within the registration connection time limit, then the user AP 400 transmits the MAC address of the wireless equipment 500 that was detected within the registration connection time limit to the member server 700 via the network 600.

(Wireless Equipment 500)

The hardware configuration of the wireless equipment 500 is not shown in the drawings, but the wireless equipment 500 is similar to a typical mobile phone, video game console, or personal computer, having a CPU, a storage device, an input device, an output device, and an interface.

The wireless equipment 500 receives authentication information for the store AP 300 in advance by means of the registration manager operating via the input device, and then stores this authentication information in the storage device. In so doing, the wireless equipment 500 is able to connect to the member server 700 via the store AP 300.

Stored in the storage device of the wireless equipment 500 is an equipment name and a MAC address. When the wireless equipment 500 detects input of power, the wireless equipment 500 transmits the equipment name and the MAC address to the member server 700 via the store AP 300.

In addition, the wireless equipment 500 receives the WEP key of the user AP 400 from the member server 700 via the store AP 300. Subsequently, the wireless equipment 500 registers the received WEP key of the user AP 400 in the storage device, and when input of power is detected, the wireless equipment 500 tries to detect the userAP 400.

(Member Server 700)

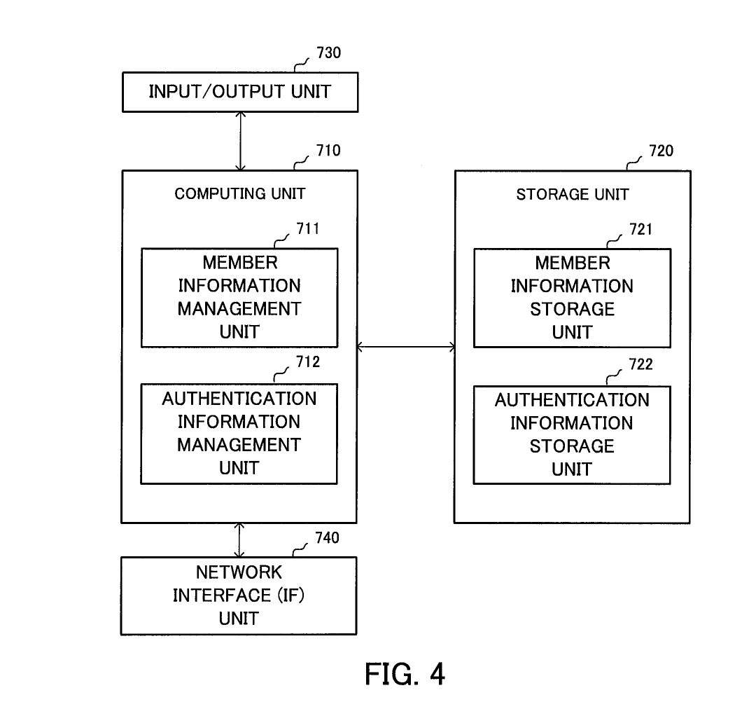

Next, the functional configuration of the member server 700 of the present embodiment will be described. FIG. 4 shows the functional configuration of the member server 700 in the authentication information registration system of the present embodiment.

The member server 700 includes a computing unit 710, a storage unit 720, an input/output unit 730, and a network interface (IF) unit 740.

(Storage Unit 720)

The storage unit 720 includes a member information storage unit 721 and an authentication information storage unit 722.

(Member Information Storage Unit 721)

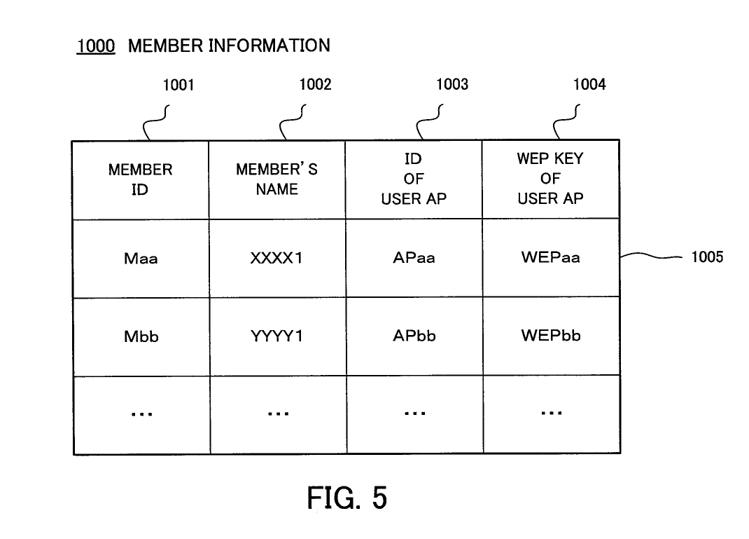

Stored in the member information storage unit 721 is member information 1000. FIG. 5 shows the data structure of the member information 1000. As shown in FIG. 5, the member information 1000 includes a field 1001 where the member ID is registered, a field 1002 where the member's name is registered, a field 1003 where the ID of the userAP 400 is registered, and a field 1004 where the WEP key of the userAP 400 is registered. In addition, in the member information 1000, the information registered in each field is associated together and stored in a single record 1005.

The registration of a member ID in the field 1001 where the member ID is registered, the registration of a member's name in the field 1002 where the member's name is registered, and the registration of the ID of the userAP 400 in the field 1003 where the ID of the userAP 400 is registered are conducted when the store issues a member's card 800.

(Authentication Information Storage Unit 722)

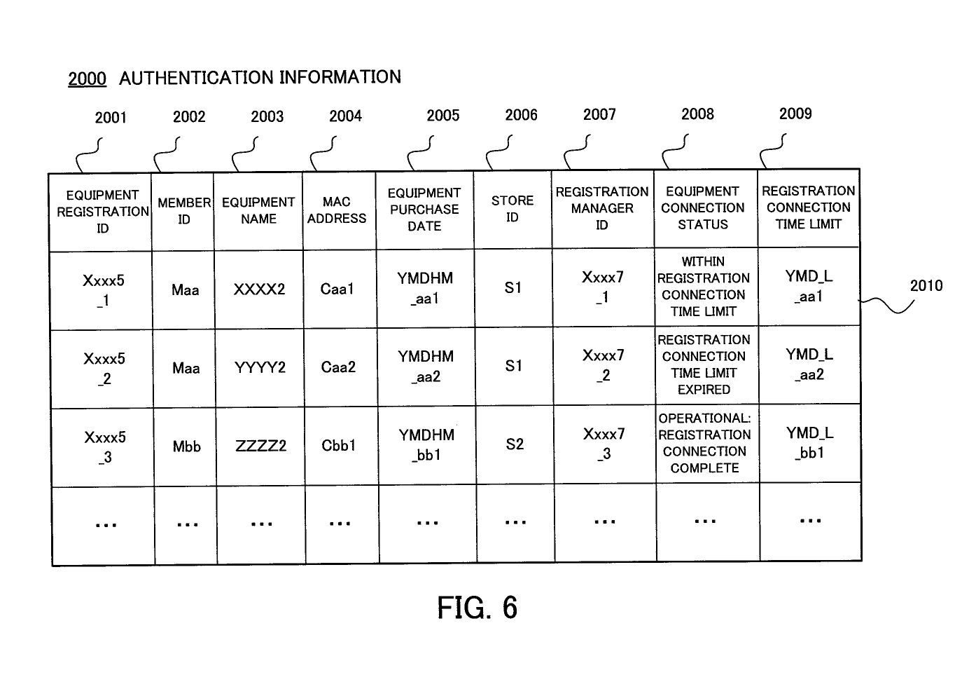

Stored in the authentication information storage unit 722 is authentication information 2000. FIG. 6 shows the data structure of the authentication information 2000. As shown in FIG. 6, the authentication information 2000 includes a field 2001 where the equipment registration ID is registered, a field 2002 where the member ID is registered, a field 2003 where the equipment name is registered, a field 2004 where the MAC address is registered, a field 2005 where the equipment purchase date is registered, a field 2006 where the store ID is registered, a field 2007 where the registration manager ID is registered, a field 2008 where the equipment connection status is registered, and a field 2009 where the registration connection time limit is registered. In addition, in the authentication information 2000, the information registered in each field is associated together and stored in a single record 2010.

The equipment connection status may be “Within registration connection time limit”, which indicates a state still within the registration connection time limit, “Registration connection time limit expired”, which indicates a state where the registration connection time limit has expired, or “Operational: registration connection complete”, which indicates a state wherein registration connection has been conducted and the equipment is operational. The initial value of the field 2008 where the equipment connection status is registered is “Within registration connection time limit”.

(Computing Unit 710)

The computing unit 710 includes a member information management unit 711 and an authentication information management unit 712.

(Member Information Management Unit 711)

By searching the member information 1000, the member information management unit 711 specifies the ID of the userAP 400 corresponding to the member ID received from the store terminal 200. The member information management unit 711 then transmits, via the network 600, information requesting the transmission of the WEP key currently in use with respect to the userAP 400 specified by the specified ID of the userAP 400. Subsequently, the member information management unit 711 receives the WEP key currently in use from the user AP 400, and then registers the acquired WEP key in the field 1004 where the WEP key of the user AP is registered in the member information 1000. At this point, if a WEP key is already registered in the field 1004 where the WEP key of the user AP is registered, then the field is updated with the acquired WEP key.

(Authentication Information Management Unit 712)

The authentication information management unit 712 receives a member ID, a store ID, a registration manager ID, and an equipment purchase date from the store terminal 200 via the network IF unit 740. Subsequently, the authentication information management unit 712 searches the member information 1000, and determines whether or not the received member ID is registered in the member information 1000. If it is determined as a result that the received member ID is not registered in the member information 1000, then the authentication information management unit 712 transmits advance registration failure information, which indicates that advance registration cannot be performed, to the store terminal 200 via the network IF unit 740. On the other hand, if it is determined as a result that the received member ID is registered in the member information 1000, then the authentication information management unit 712 transmits information requesting input of the registration connection time limit to the store terminal 200 via the network IF unit 740.

Upon receiving the registration connection time limit from the store terminal 200 via the network IF unit 740, the authentication information management unit 712 creates an equipment registration ID, and also creates a new record 2010 in the authentication information 2000. Subsequently, the created equipment registration ID is registered in the field 2001 where the equipment registration ID is registered, the received member ID is registered in the field 2002 where the member ID is registered, the received equipment purchase date is registered in the field 2005 where the equipment purchase date is registered, the received store ID is registered in the field 2006 where the store ID is registered, the received registration manager ID is registered in the field 2007 where the registration manager ID is registered, and the received registration connection time limit is registered in the field 2009 where the registration connection time limit is registered. At this point, an initial value of “Within registration connection time limit” is registered in the field 2008 where the equipment connection status is registered.

The authentication information management unit 712 then transmits information to the store terminal 200 via the network IF unit 740, the information requesting power to be input into the wireless equipment 500.

Upon receiving the equipment name of the wireless equipment 500 and the MAC address of the wireless equipment 500 from the wireless equipment 500 via the network IF unit 740, the authentication information management unit 712 registers the received equipment name being registered in the field 2003 where the equipment name is registered of the authentication information 2000, and the received MAC address being registered in the field 2004 where the MAC address is registered.

The authentication information management unit 712 then reads the WEP key currently in use by the user AP 400 from the authentication information 2000, and transmits this WEP key to the wireless equipment 500 via the network IF unit 740. In addition, the authentication information management unit 712 reads the MAC address and the registration connection time limit of the wireless equipment 500 from the authentication information 2000, and transmits this information to the userAP 400 via the network IF unit 740.

The authentication information management unit 712 then creates completed advance registration information 3000 that includes the equipment purchase date when the wireless equipment 500 was purchased, the member's name, the purchased equipment name, the ID of the userAP, the registration connection time limit, the equipment registration ID, and the registration manager ID. The authentication information management unit 712 then transmits the completed advance registration information 3000 to the store terminal 200 via the network IF unit 740.

The completed advance registration information 3000 herein is created by creating a single record that associates a member's name and the ID of a user AP read from the member information 1000 together with the equipment name of purchased wireless equipment 500, an equipment registration ID, an equipment purchase date when wireless equipment 500 was purchased, a registration manager ID, and a registration connection time limit read from the authentication information 2000.

In addition, the authentication information management unit 712 receives the MAC address of wireless equipment 500 whose registration connection time limit has expired from the userAP 400 via the network IF unit 740. Subsequently, in the authentication information 2000, the authentication information management unit 712 updates the equipment connection status corresponding to the received MAC address of the wireless equipment 500 whose registration connection time limit has expired, the equipment connection status being updated from “Within registration connection time limit” to “Registration connection time limit expired”.

The authentication information management unit 712 also receives, from the userAP 400 via the network IF unit 740, the MAC address of wireless equipment 500 that was detected within the registration connection time limit. Subsequently, in the authentication information 2000, the authentication information management unit 712 updates the equipment connection status corresponding to the received MAC address of the wireless equipment 500 that was detected within the registration connection time limit, the equipment connection status being updated from “Within registration connection time limit” to “Operational: registration connection complete”.

(Input/Output Unit 730)

The input/output unit 730 receives input from an administrator who manages the member server 700. In addition, the input/output unit 730 outputs information within the member server 700 to devices such as a display or a printing device.

(Network IF Unit 740)

The network IF unit 740 controls the communication of information via the network 600, the store terminal 200, the store AP 300, and the user AP 400.

(Hardware Configuration)

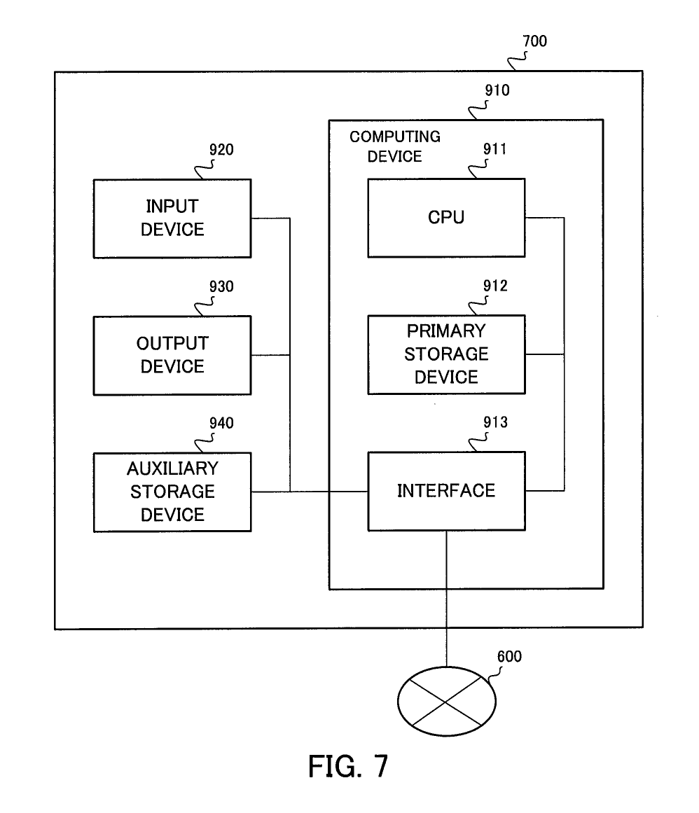

FIG. 7 shows the hardware configuration of the member server 700 in the authentication information registration system of the present embodiment.

By way of example, the member server 700 configured as described in the foregoing may be realized as shown in FIG. 7, using a typical computer provided with a computing device 910, an input device 920 such as a keyboard and/or mouse, a output device 930 such as a display, and a auxiliary storage device 940 such as a HDD or a portable storage medium such as a CD-ROM or DVD-ROM, wherein the computing device 910 further includes a CPU 911, a primary storage device 912 such as RAM, and an interface 913 that communicates with a store terminal 200, a store AP 300, and an user AP 400 via the network 600 while additionally enabling communications among the input device 920, the output device 930, and the auxiliary storage device 940.

A NIC (Network Interface Card) or similar device may be used as the interface 913 herein.

For example, it is possible for the storage unit 720 shown in FIG. 4 to be realized by the auxiliary storage device 940, while the computing unit 710 may be realized as a result of loading a predetermined program stored in the auxiliary storage device 940 into the primary storage device 912 and executing the program using the CPU 911.

The predetermined program may also be downloaded to the auxiliary storage device 940 from the network 600 via the interface 913, subsequently loaded into the primary storage device 912, and then executed by the CPU 911.

(Processing Sequence)

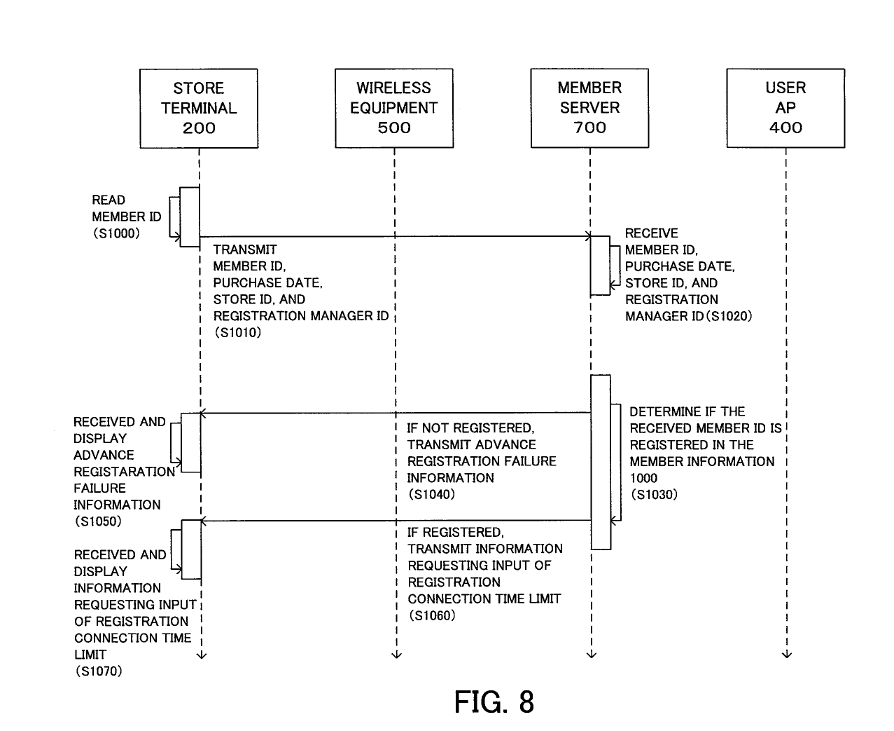

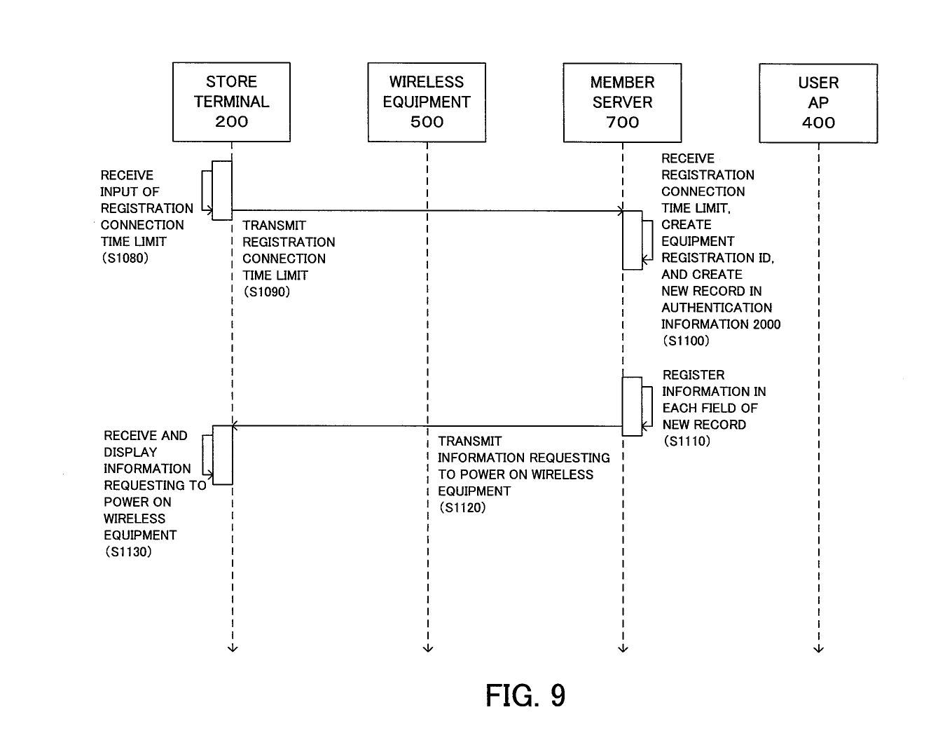

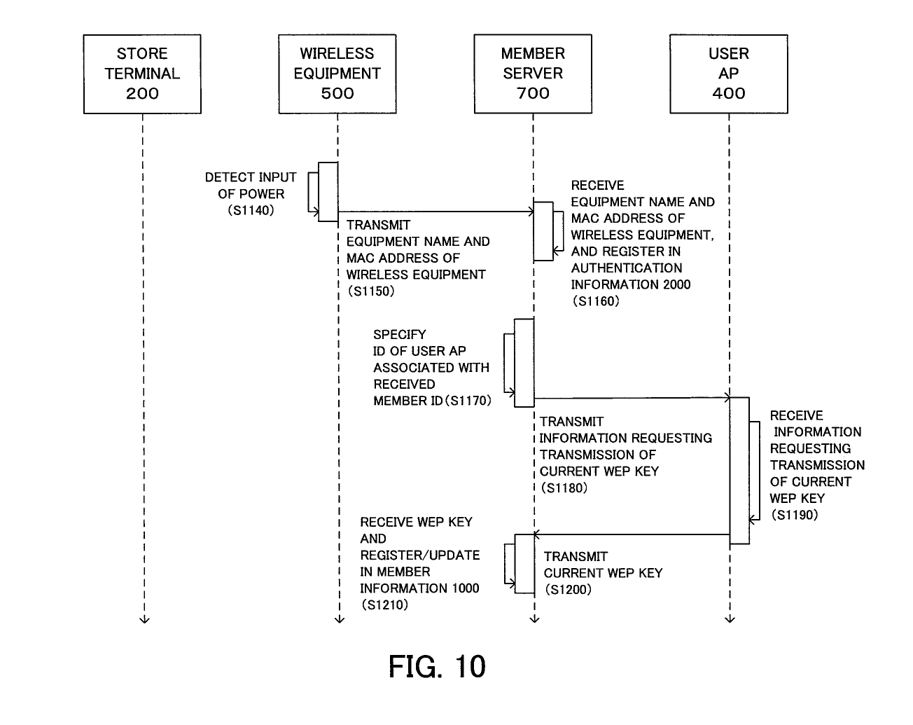

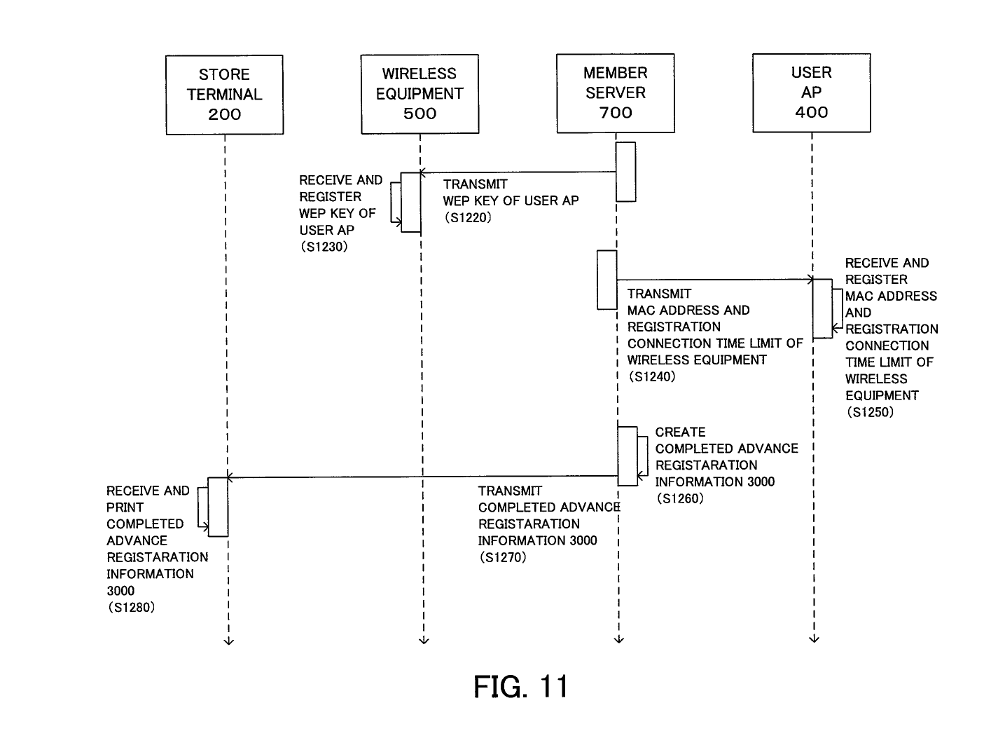

Next, the processing of the authentication information registration system of the present embodiment will be described with reference to FIGS. 8 to 13.

(Processing for Advance Registration at the Store Where the Wireless Equipment is Purchased)

First, the processing for advance registration conducted at the store where the wireless equipment is purchased as part of the authentication information registration system of the present embodiment will be described.

FIGS. 8 to 11 are diagrams explaining the processing for advance registration conducted at the store where the wireless equipment is purchased as part of the authentication information registration system of the present embodiment.

First, a user specifies wireless equipment 500 and purchases the wireless equipment 500. At that time, the user presents the member's card 800 he or she possesses to the registration manager.

The card reader 240 of the store terminal 200 reads the member ID stored in the member's card 800 by means of a physical interaction with the member's card 800 (such as electromagnetic induction or electrostatic induction, for example) chosen according to the physical characteristics of the member's card 800 (S1000). The control device 210 of the store terminal 200 then transmits the member ID read using the card reader 240 to the member server 700 via the network 600 (S1010). At this point, the control device 210 also transmits a store ID and registration manager ID read from the storage device 220, as well as an equipment purchase date taken to be the date when the member ID is read along with the member ID, the above being transmitted to the member server 700 via the communications equipment 230.

The authentication information management unit 712 of the member server 700 then receives the member ID, the equipment purchase date, the store ID, and the registration manager ID via the network 600 (S1020). The authentication information management unit 712 then searches the member information 1000 within the member information storage unit 721, and determines whether or not the received member ID is registered in the member information 1000 (S1030).

If it is determined as a result that the received member ID is not registered in the member information 1000, then the authentication information management unit 712 transmits advance registration failure information indicating that advance registration cannot be performed to the store terminal 200 via the network 600 (S1040).

The control device 210 of the store terminal 200 receives the advance registration failure information from the member server 700, and displays the advance registration failure information on the display panel 250 (S1050). Subsequently, the registration manager informs the user that advance registration of the wireless equipment 500 cannot be conducted.

On the other hand, if the authentication information management unit 712 determines that the received member ID is registered in the member information 1000, then the authentication information management unit 712 transmits information requesting input of the registration connection time limit (for example, the time until the user returns home) to the store terminal 200 via the network 600 (S1060).

The control device 210 of the store terminal 200 receives the information requesting input of the registration connection time limit from the member server 700, and then displays the information requesting input of the registration connection time limit on the display panel 250 (S1070). The control device 210 of the store terminal 200 then receives input of the registration connection time limit via the input device 260 (S1080). The registration connection time limit thus input is then transmitted to the member server 700 via the network 600 (S1090).

Upon receiving the registration time limit information from the store terminal 200, the authentication information management unit 712 creates an equipment registration ID, and also creates a new record 2010 in the authentication information 2000 (S1100). Subsequently, the created equipment registration ID is registered in the field 2001 where the equipment registration ID is registered, the received member ID is registered in the field 2002 where the member ID is registered, the received equipment purchase date is registered in the field 2005 where the equipment purchase date is registered, the received store ID is registered in the field 2006 where the store ID is registered, the received registration manager ID is registered in the field 2007 where the registration manager ID is registered, and the received registration connection time limit is registered in the field 2009 where the registration connection time limit is registered (S1110).

Next, the authentication information management unit 712 transmits information requesting to power on the wireless equipment 500 to the store terminal 200 via the network 600 (S1120).

Next, the control device 210 of the store terminal 200 receives, from the member server 700, information requesting to power on wireless equipment 500, and then displays information requesting to power on the wireless equipment 500 on the display panel 250 (S1130).

When the information prompting the powering on of the wireless equipment 500 is displayed on the display panel 250, the registration manager is able to know when to power on the wireless equipment 500 inside the store.

When the input of power is detected (S1140), the wireless equipment 500 connects to the member server 700 via a store AP 300 for which the operations for registering authentication information with respect to the wireless equipment 500 have been completed in advance by the registration manager. The wireless equipment 500 then transmits the equipment name and the MAC address of the wireless equipment 500 to the member server 700 (S1150).

The authentication information management unit 712 receives the equipment name and the MAC address of the wireless equipment 500 from the wireless equipment 500. In addition, in the record of the authentication information 2000 that was created in S1100, the authentication information management unit 712 registers the received equipment name in the field 2003 where the equipment name is registered, and also registers the received MAC address in the field 2004 where the MAC address is registered (S1160).

Next, the member information management unit 711 searches the member information 1000 and specifies the ID of the userAP 400 corresponding to the member ID received in S1020 (S1170). The member information management unit 711 then transmits, via the network 600, information requesting the transmission of the WEP key currently in use to the userAP 400 specified by the ID of the userAP 400 specified in S1170 (S1180). Upon receiving the information requesting the transmission of the WEP key currently in use from the member server 700 via the network 600 (S1190), the userAP 400 transmits the WEP key currently in use to the member server 700 via the network 600 (S1200).

The member information management unit 711 receives the WEP key currently in use from the userAP 400 via the network 600, and then registers the acquired WEP key in the field 1004 where the WEP key of the user AP is registered (S1210), the WEP key being registered in association with the user AP corresponding to the member ID in the member information 1000 that was received in S1020. At this point, if a WEP key is already registered in the field 1004 where the WEP key of the userAP is registered, then the field is updated with the acquired WEP key.

Once the member information management unit 711 has registered or updated the field 1004 where the WEP key of the user AP is registered in the member information 1000, the authentication information management unit 712 reads the WEP key currently in use by the user AP 400 from the authentication information 2000, and then transmits the WEP key currently in use by the user AP 400 to the wireless equipment 500 via the store AP 300 (S1220).

The wireless equipment 500 receives the WEP key of the user AP 400 from the member server 700 via the store AP 300, and then registers the WEP key in a storage device (not shown in the drawings) of the wireless equipment 500 (S1230).

In addition, the authentication information management unit 712 reads the MAC address and registration connection time limit of the wireless equipment 500 from the authentication information 2000, and then transmits the MAC address and the registration connection time limit of the wireless equipment 500 to the userAP 400 via the network 600 (S1240).

The user AP 400 receives the MAC address and the registration connection time limit of the wireless equipment 500 from the member server 700 via the network 600, and then registers the received MAC address and registration connection time limit in a storage device (not shown in the drawings) of the user AP 400 (S1250).

In addition, the authentication information management unit 712 creates completed advance registration information 3000 that includes the member's name, the ID of the user AP, the equipment name of the purchased wireless equipment 500, the equipment registration ID, the purchase date when the wireless equipment 500 was purchased, the registration manager ID, and the registration connection time limit (S1260). The completed advance registration information 3000 herein is created by creating a single record that associates the member's name and the ID of the userAP read from the member information 1000 together with the equipment name of the purchased wireless equipment 500, the equipment registration ID, the equipment purchase date when wireless equipment 500 was purchased, the registration manager ID, and the registration connection time limit read from the authentication information 2000. Subsequently, the authentication information management unit 712 transmits the completed advance registration information 3000 to the store terminal 200 via the network 600 (S1270).

Upon receiving the completed advance registration information 3000 via the communications equipment 230, the control device 210 of the store terminal 200 causes the completed advance registration information 3000 to be printed by the printer 270 (S1280). The registration manager then gives the item with the completed advance registration information 3000 printed thereupon (a sheet of paper such as a purchase receipt, for example) to the user.

(Processing After Advance Registration at the Store)

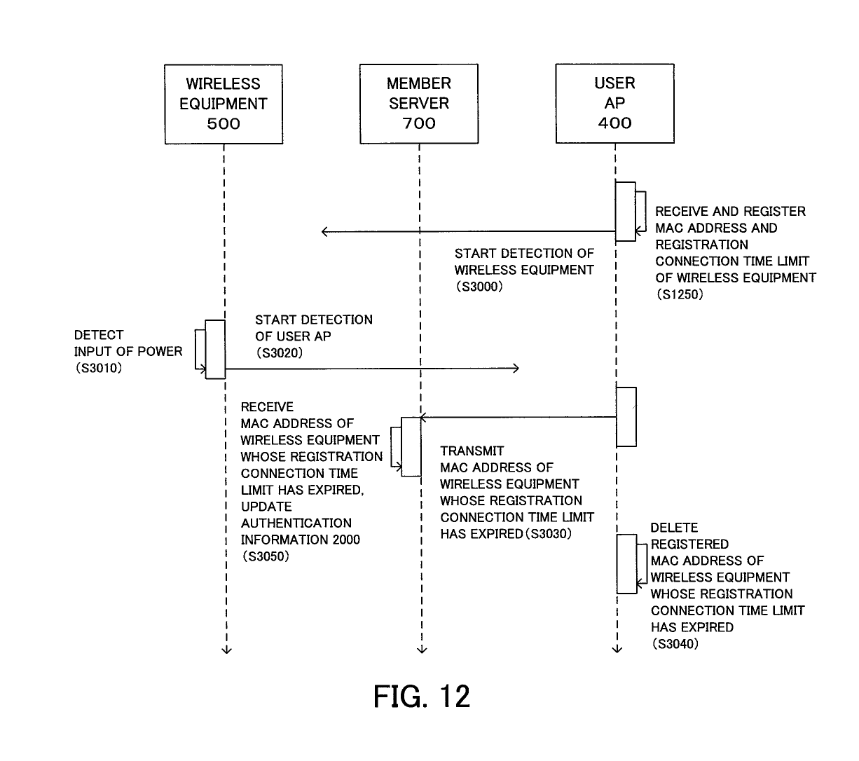

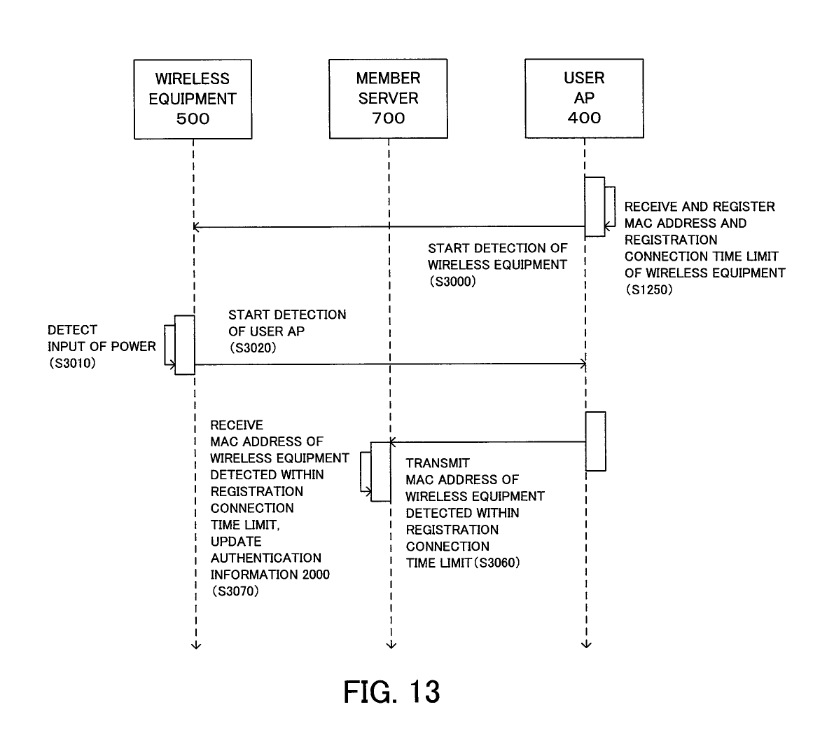

Next, the processing conducted after advance registration at the store as part of the authentication information registration system of the present embodiment will be described with reference to FIGS. 12 and 13.

Once the user AP 400 has registered the MAC address and the registration connection time limit received from the member server 700 in S1250 in the storage device (not shown in the drawings) of the userAP 400, the userAP 400 begins detection of the wireless equipment 500 (S3000).

Meanwhile, the user returns home with the purchased wireless equipment 500 and subsequently powers on the wireless equipment 500. When the wireless equipment 500 detects the input of power (S3010), the wireless equipment 500 begins detection of the user AP 400 (S3020).

The processing that is subsequently conducted will be described in two parts, the first part describing the case wherein the user AP 400 does not detect the wireless equipment 500 within the registration connection time limit, and the second part describing the case wherein the user AP 400 detects the wireless equipment 500 within the registration connection time limit.

(i) The case wherein the user AP 400 does not detect the wireless equipment 500 within the registration connection time limit

FIG. 12 is a diagram explaining the processing conducted after advance registration at the store as part of the authentication information registration system of the present embodiment, in the case where the user AP 400 does not detect the wireless equipment 500 within the registration connection time limit.

When the registration connection time limit expires, the user AP 400 transmits the MAC address of the wireless equipment 500 whose registration connection time limit has expired to the member server 700 via the network 600 (S3030). In addition, the user AP 400 deletes registered the MAC address of the wireless equipment 500 whose registration connection time limit has expired (S3040).

The authentication information management unit 712 of the member server 700 receives the MAC address of the wireless equipment 500 whose registration connection time limit has expired from the user AP 400 via the network 600. Subsequently, in the authentication information 2000, the authentication information management unit 712 updates the equipment connection status associated with the received MAC address of the wireless equipment 500 whose registration connection time limit has expired, the equipment connection status being updated from “Within registration connection time limit” to “Registration connection time limit expired” (S3050).

(ii) The case wherein the userAP 400 detects the wireless equipment 500 within the registration connection time limit

FIG. 13 is a diagram explaining the processing conducted after advance registration at the store as part of the authentication information registration system of the present embodiment, in the case where the user AP 400 detects the wireless equipment 500 within the registration connection time limit.

When the wireless equipment 500 is detected within the registration connection time limit, the user AP 400 transmits the MAC address of the wireless equipment 500 that was detected within the registration connection time limit to the member server 700 via the network 600 (S3060).

The authentication information management unit 712 of the member server 700 receives the MAC address of the wireless equipment 500 that was detected within the registration connection time limit from the userAP 400 via the network 600. Subsequently, in the authentication information 2000, the authentication information management unit 712 updates the equipment connection status associated with the MAC address of the wireless equipment 500 that was detected within the registration connection time limit, the equipment connection status being updated from “Within registration connection time limit” to “Operational: registration connection complete” (S3070).

(Print Example of the Completed Advance Registration Information 3000)

Next, a print example of the completed advance registration information 3000 that is printed by the printer 270 of the store terminal 200 will be described.

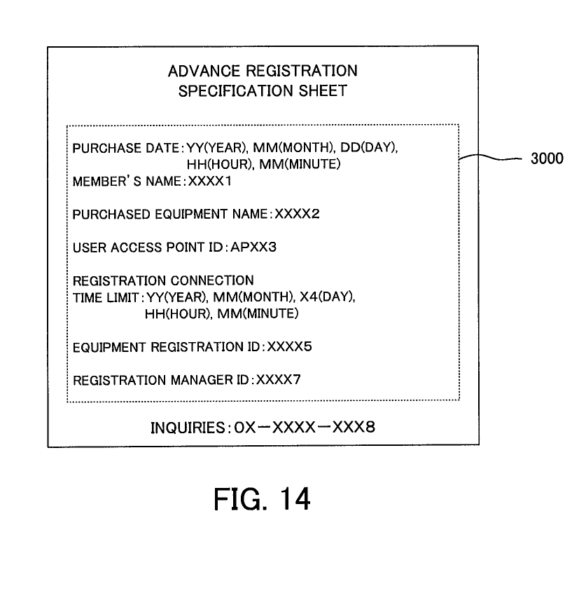

FIG. 14 is a print example of the completed advance registration information 3000 that is printed by the printer 270 of the store terminal 200.

The completed advance registration information 3000 is printed by the printer 270 on the receipt provided when the wireless equipment 500 is purchased, for example. The purchase date when the wireless equipment 500 was purchased, the member's name, the purchased equipment name, the ID of the user AP, the registration connection time limit, the equipment registration ID, and the registration manager ID are printed. By printing the registration connection time limit, the user is able to know the registration connection time limit, and thus is able to power on the wireless equipment 500 at the user's home within the registration connection time limit.

According to the present invention described in the foregoing, the registration of the MAC address of the purchased wireless equipment 500 in the user AP 400, as well as the registration of the WEP key of the user AP 400 in the wireless equipment 500 can be conducted at the store where the wireless equipment 500 is purchased. For this reason, the user need not conduct cumbersome registration operations at home. Moreover, users who are not skilled at registration operations need not request a person offering services for performing registration operations to come to the user's home and perform the registration operations, thereby eliminating large costs.

In addition, since the present invention can also be used in the case where there exists a plurality of wireless equipments in the home, it is not necessary for the user to conduct cumbersome registration operations every time a new piece of wireless equipment is purchased. Moreover, it becomes no longer necessary for users who are not skilled at performing operations for registering authentication information to request a person offering services for performing registration operations to come to the user's home and perform registration operations every time a new piece of wireless equipment is purchased.

1. An authentication information registration system, comprising a server, a device that acts as a first access point disposed in relation to a user, a terminal installed at a store that receives wireless equipment, and a device that acts as a second access point disposed in relation to the terminal being connected via a network; wherein
the terminal includes means for reading member identification information from a recording medium possessed by a user and storing member identification information identifying the user and then transmitting such member identification information to the server via a network;
the server includes
means for storing the member identification information in association with access point identification information identifying the device that acts as the first access point,
means for receiving the member identification information from the terminal, and subsequently receiving wireless equipment identification information from the wireless equipment via the device that acts as the second access point,
means for specifying the access point identification information associated with the received member identification information, and
means for transmitting, via the network, the wireless equipment identification information received from the wireless equipment to the device that acts as the first access point that was identified using the specified access point identification information; and
the device that acts as the first access point includes means for receiving the wireless equipment identification information from the server via a network and then registering the wireless equipment identification information received from the server.

2. The authentication information registration system according to claim 1, wherein
the terminal includes means for receiving input of a registration connection time limit lasting until the device that acts as the first access point first detects the wireless equipment, and for transmitting the input to the server;
the server includes means for matching the registration connection time limit received from the terminal with the wireless equipment identification information of the wireless equipment, and then transmitting the information to the device that acts as the first access point; and
the device that acts as the first access point includes
means for receiving the registration connection time limit from the server, and
means for deleting the wireless equipment identification information of the wireless equipment in the case where the wireless equipment is not detected within the received registration connection time limit.

3. The authentication information registration system according to claim 2, wherein
the server includes means for creating, and transmitting to the terminal, registration information that includes the wireless equipment identification information transmitted to the device that acts as the first access point as well as the registration connection time limit; and
the terminal includes means for receiving the registration information from the server and then printing the received registration information.

4. A server that causes equipment identification information identifying purchased wireless equipment to be registered in a device that acts as a first access point connected to a network and disposed in relation to a user, the server comprising:
means for storing member identification information identifying the user in association with access point identification information identifying the device that acts as the first access point;
means for receiving the member identification information from a terminal installed at the store that receives the wireless equipment, and subsequently receiving the equipment identification information from the wireless equipment via a device that acts as a second access point disposed in relation to the terminal;
means for specifying the access point identification information associated with the received member identification information; and
means for transmitting, via a network, the equipment identification information received by the receiving means to the device that acts as the first access point that was identified by the specified access point identification information.
